(19) United States
(12) Patent Application Publication
(10) Pub. No.: US 2025/0232450 A1
(43) Pub. Date: Jul. 17, 2025

(54) EDGE EXTRACTION METHOD AND APPARATUS, AND ELECTRONIC DEVICE AND STORAGE MEDIUM

(71) Applicant: BEIJING ZITIAO NETWORK TECHNOLOGY CO., LTD., Beijing (CN)

(72) Inventor: Yuanlue ZHU, Beijing (CN)

(21) Appl. No.: 18/730,717

(22) PCT Filed: Jan. 16, 2023
(86) PCT No.: PCT/CN2023/072410

§ 371 Date: Jul. 19, 2024

(30) Foreign Application Priority Data
Jan. 20, 2022 (CN) 202210067538.9

(51) Int. Cl. G06T 7/13; G06T 3/4007; G06T 5/30; G06T 5/60; G06T 5/73

(52) U.S. Cl. CPC G06T 7/13; G06T 3/4007; G06T 5/30; G06T 5/60; G06T 5/73; G06T 2207/20081; G06T 2207/20084; G06T 2207/20192

(57) ABSTRACT

The present disclosure provides an edge extraction method, apparatus, electronic device, and storage medium. The edge extraction method comprises: acquiring a target image to be extracted; and inputting the target image to be extracted to a target edge extraction model to obtain a target edge mask image corresponding to the target image to be extracted. The target edge extraction model is trained by: acquiring a sample initial image to be extracted and a sample initial edge mask image corresponding to the sample initial image to be extracted; performing image enhancement processing on the sample initial image to be extracted to obtain a sample target image to be extracted with a target size, and performing image enhancement processing on the sample initial edge mask image to obtain a sample target edge mask image with the target size; and training an initial deep learning model according to the sample target image to be extracted and the sample target edge mask image corresponding to the sample initial image to be extracted to obtain the target edge extraction model.

### CROSS-REFERENCE TO RELATED APPLICATION(S)

This application claims priority to Chinese Patent Application No. 202210067538.9, filed with the China National Intellectual Property Administration on Jan. 20, 2022, the disclosure of which is incorporated herein by reference in its entirety.

### FIELD

The present disclosure relates to the technical field of image processing, and for example, to an edge extraction method and apparatus, an electronic device, and a storage medium.

### BACKGROUND

An image edge, as a fundamental feature of an image, integrates a large amount of image information. Image edge detection is a fundamental problem in the image processing and computer vision. The image edge usually exists among a target, a background, and an area, making it very difficult to detect and extract the image edge.

During detection and extraction of the image edge based on the image edge detection and extraction technology, there is a problem that a result of the image edge extraction is rough and imprecise.

### SUMMARY

The present disclosure provides an edge extraction method, apparatus, electronic device, and storage medium, so as to achieve an effect of extracting the edge information in an image more accurately.

In a first aspect, the present disclosure provides an edge extraction method. The method comprises:
acquiring a target image to be extracted; and
inputting the target image to be extracted to a target edge extraction model to obtain a target edge mask image corresponding to the target image to be extracted,
wherein the target edge extraction model is trained by:
acquiring a sample initial image to be extracted and a sample initial edge mask image corresponding to the sample initial image to be extracted;
performing image enhancement processing on the sample initial image to be extracted to obtain a sample target image to be extracted with a target size, and performing image enhancement processing on the sample initial edge mask image to obtain a sample target edge mask image with the target size; and
training an initial deep learning model according to the sample target image to be extracted and the sample target edge mask image corresponding to the sample initial image to be extracted to obtain the target edge extraction model.

In a second aspect, the present disclosure provides an edge extraction apparatus. The apparatus comprises:
an image acquisition module, configured for acquiring a target image to be extracted;
an edge extraction module, configured for inputting the target image to be extracted to a target edge extraction model to obtain a target edge mask image corresponding to the target image to be extracted,
wherein the target edge extraction model is obtained based on a model training apparatus, and the model training apparatus comprises:
a sample acquisition module, configured for acquiring a sample initial image to be extracted and a sample initial edge mask image corresponding to the sample initial image to be extracted;
a sample enhancement module, configured for performing image enhancement processing on the sample initial image to be extracted to obtain a sample target image to be extracted with a target size, and performing image enhancement processing on the sample initial edge mask image to obtain a sample target edge mask image with the target size; and
a model training module, configured for training an initial deep learning model according to the sample target image to be extracted and the sample target edge mask image corresponding to the sample initial image to be extracted to obtain the target edge extraction model.

In a third aspect, the present disclosure further provides an electronic device. The electronic device comprises:
one or more processors;
a storage apparatus, configured for storing one or more programs.
wherein the one or more programs, when executed by the one or more processors, cause the one or more processors to implement the edge extraction method provided by the present disclosure.

In a fourth aspect, the present disclosure further provides a computer-readable storage medium, storing a computer program. The computer program, when executed by a processor, implements the edge extraction method provided by the present disclosure.

In a fifth aspect, the present disclosure further provides a computer program product, comprising a computer program carried on a non-transitory computer-readable medium, wherein the computer program comprises program codes used for implementing the edge extraction method provided by the present disclosure.

### BRIEF DESCRIPTION OF THE DRAWINGS

FIG. 1 is a flowchart of an edge extraction method according to Embodiment I of the present disclosure;

FIG. 2 is a flowchart of a training method of a target edge extraction model according to Embodiment II of the present disclosure;

FIG. 3 is a flowchart of a training method of a target edge extraction model according to Embodiment III of the present disclosure;

FIG. 4 is a flowchart of a training method of a target edge extraction model according to Embodiment IV of the present disclosure;

FIG. 5 is a schematic diagram of a sample initial image to be extracted according to Embodiment V of the present disclosure;

FIG. 6 is a schematic diagram of a sample target image to be extracted according to Embodiment V of the present disclosure;

FIG. 7 is a schematic diagram of a target edge mask image output by a target edge extraction model according to Embodiment V of the present disclosure;

FIG. 8 is a schematic diagram of a target edge mask image after image brightness adjustment according to Embodiment V of the present disclosure;

FIG. 9 is a schematic structural diagram of an edge extraction apparatus and a model training apparatus according to Embodiment VI of the present disclosure; and

FIG. 10 is a schematic structural diagram of an electronic device according to Embodiment VII of the present disclosure.

### DETAILED DESCRIPTION OF EMBODIMENTS

The embodiments of the present disclosure will be described below with reference to the accompanying drawings. Although the accompanying drawings show some embodiments of the present disclosure, the present disclosure may be implemented in various forms, and these embodiments are provided for understanding the present disclosure. The accompanying drawings and embodiments of the present disclosure are only used for illustration.

Multiple steps recorded in method implementations of the present disclosure may be executed in different orders and/or in parallel. In addition, the method implementations may comprise additional steps and/or omit the execution of the steps shown. The scope of the present disclosure is not limited in this aspect.

The term “comprise” and its variants as used herein mean widespread inclusion, namely, “comprising but not limited to”. The term “based on” is “based at least in part on”.

The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units. The modifications of “one” and “a plurality of” mentioned in the present disclosure are indicative rather than restrictive, and those skilled in the art should understand that unless otherwise stated in the context, they should be understood as “one or more”.

Messages or names of information exchanged between a plurality of apparatuses in the implementations of the present disclosure are only for illustrative purposes and are not intended to limit the messages or the scope of the information.

### Embodiment I

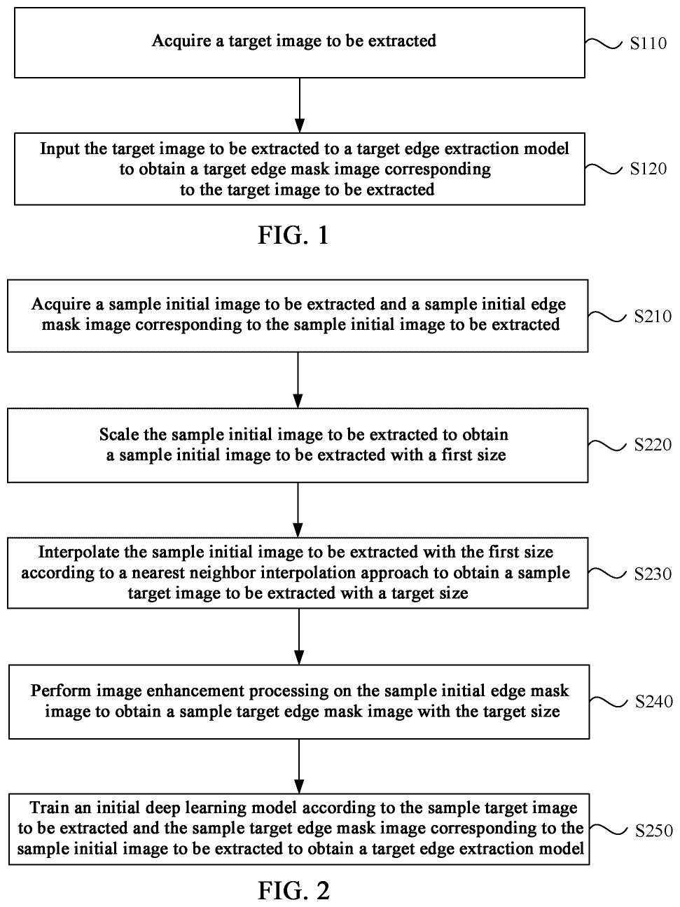

FIG. 1 is a flowchart of an edge extraction method according to Embodiment I of the present disclosure. This embodiment may be applied in a scenario of extracting an image edge. The method may be performed by an edge extraction apparatus. The apparatus may be implemented by software and/or hardware and may be configured in a terminal and/or a server to implement the edge extraction method in the embodiments of the present disclosure.

As shown in FIG. 1, the method of this embodiment may specifically comprise: S110. Acquire a target image to be extracted.

The target image to be extracted may be an original image for edge extraction.

The target image to be extracted may be acquired through downloading, capturing, drawing, uploading, and the like.

S120. Input the target image to be extracted to a target edge extraction model to obtain a target edge mask image corresponding to the target image to be extracted.

The target edge mask image may be an image corresponding to the target image to be extracted and having edge information. The target edge extraction model may be a trained model that can be used for performing edge extraction on an image.

The target image to be extracted is input to the target edge extraction model and is then processed, and an output result is used as the target edge mask image corresponding to the target image to be extracted.

The target edge extraction model is trained based on the following method, comprising the following steps:

Step I. Acquire a sample initial image to be extracted and a sample initial edge mask image corresponding to the sample initial image to be extracted.

The sample initial image to be extracted may be an original sample image for edge extraction. The sample initial edge mask image may be an image corresponding to the sample initial image to be extracted and used for characterizing edge information.

The sample initial image to be extracted and the sample initial edge mask image corresponding to the sample initial image to be extracted may be acquired from a database. It is also possible to first acquire the sample initial image to be extracted and then label the edge information of the sample initial image to be extracted to obtain the initial edge mask image corresponding to the sample initial image to be extracted.

Step II. Perform image enhancement processing on the sample initial image to be extracted to obtain a sample target image to be extracted with a target size, and perform image enhancement processing on the sample initial edge mask image to obtain a sample target edge mask image with the target size.

The image enhancement processing may be an image processing approach that improves the visual effect of an image. The image enhancement processing can purposefully emphasize the overall or local characteristics of an image, highlight features of interest, and suppress features of disinterest. The target size may be a preset size of an output image, such as 512×512 and 1024×1024. The sample target image to be extracted may be an image obtained after performing the image enhancement processing on the sample initial image to be extracted, and the sample target edge mask image may be an image obtained after performing the image enhancement processing on the sample initial edge mask image.

The image enhancement processing is performed on the sample initial image to be extracted, so as to add some information or transformation data to the sample initial image to be extracted to highlight the features of interest in the sample initial image to be extracted. Size transformation is also performed on the sample initial image to be extracted that has been subjected to the image enhancement processing, so as to obtain the sample target image to be extracted with the target size. The image enhancement processing is performed on the sample initial edge mask image, so as to add some information or transformation data to the sample initial edge mask image to highlight the features of interest in the sample initial image to be extracted. Size transformation is also performed on the sample initial edge mask image that has been subjected to the image enhancement processing, so as to obtain the sample initial edge mask image with the target size.

The purpose of performing the image enhancement processing on the sample initial image to be extracted to obtain the sample target image to be extracted with the target size is to achieve the sample expansion. The purpose of performing the image enhancement processing on the sample initial edge mask image to obtain the sample target edge mask image with the target size is to highlight the edge information in the sample initial edge mask image, so as to improve the sample quality.

Step III. Train an initial deep learning model according to the sample target image to be extracted and the sample target edge mask image corresponding to the sample initial image to be extracted to obtain the target edge extraction model.

The initial deep learning model comprises a convolutional neural network model, and the convolutional neural network model comprises at least one of a u2net model, a unet model, a deeplab model, a transformer model, and a pidinet model.

The initial deep learning model is used as a current deep learning model. The sample target image to be extracted is input to the current deep learning model to obtain an output image. The output image is compared with the sample target edge mask image corresponding to the sample target image to be extracted to obtain a current loss function. If the loss function does not meet a requirement, a plurality of parameters in the current deep learning model are adjusted according to the current loss function. The adjusted deep learning model is then used as a current deep learning model, and the operation of inputting the sample target image to be extracted to the current deep learning model to obtain an output image is performed. If the loss function meets the requirement, the current deep learning model may be used as the target edge extraction model.

If the current loss function still does not meet the requirement after the training is performed for a preset number of times, the current deep learning model obtained from the last training may be used as the target edge extraction model.

Based on the technical solutions of the embodiments of the present disclosure, the target edge mask image may be processed to weaken irrelevant information and thin the edge information. The method further comprises, after a target edge mask image corresponding to the target image to be extracted is obtained:

Adjusting the image brightness of the target edge mask image based on a preset color lookup table.

A Lookup table (LUT) is used for adjusting color values of pixel points, which may comprise: adjusting color information of each pixel point by the LUT to obtain new color information of the pixel point.

Processing the target edge mask image according to the preset color lookup table may comprise: adjusting colors of edge-related pixel points in the target edge mask image so as to adjust the image brightness of the target edge mask image.

Based on the technical solutions of the embodiments of the present disclosure, the contour recognition processing may be performed on a plurality of edge pixel points in the target edge mask image to obtain a hierarchical relationship of the plurality of edge pixel points, which is helpful in the subsequent processing such as the display or adding effects according to this hierarchical relationship. The method further comprises, after obtaining a target edge mask image corresponding to the target image to be extracted:

Recognizing edge pixel points in the target edge mask image based on a preset contour recognition algorithm, and storing the recognized edge pixel points in the form of point vectors.

The target edge mask image may comprise edge pixel points and non-edge pixel points. Exemplarily, the target edge mask image may be a binary image. For example, the edge pixel points are white, and the non-edge pixel points are black. The contour recognition algorithm may be an algorithm used for determining the hierarchical relationship of the plurality of edge pixel points in the contour, such as the FindContours function in OpenCV. The hierarchical relationship may be used for representing an order of the plurality of edge pixel points. A point vector may comprise a position of an edge pixel point and a direction to a next edge pixel point from the edge pixel point.

The edge pixel points in the target edge mask image are recognized based on the preset contour recognition algorithm, such that the point vector of each edge pixel point may be obtained. The plurality of point vectors may be stored for the subsequent processing such as the display or adding effects based on the plurality of point vectors to achieve a gradual change process.

According to technical solutions of the embodiments of the present disclosure, the target image to be extracted is acquired and input to the target edge extraction model to obtain the target edge mask image corresponding to the target image to be extracted, such that the edge extraction of the image is performed. Moreover, the sample initial image to be extracted and the sample initial edge mask image corresponding to the sample initial image to be extracted are acquired; the image enhancement processing is performed on the sample initial image to be extracted to obtain the sample target image to be extracted with the target size, and the image enhancement processing is performed on the sample initial edge mask image to obtain the sample target edge mask image with the target size for sample expansion and image quality improvement. The initial deep learning model is trained according to the sample target image to be extracted and the sample target edge mask image corresponding to the sample target image to be extracted, such that the target edge extraction model is obtained. This solves the problem that the result of image edge extraction is rough and imprecise, and thus achieves the effect of extracting edge information in an image more accurately.

### Embodiment II

FIG. 2 is a flowchart of a training method of a target edge extraction model according to Embodiment II of the present disclosure. This embodiment is explained based on any technical solution of the embodiments of the present disclosure, and the method for performing the image enhancement processing on a sample initial image to be extracted may refer to the technical solution of this embodiment. The explanations of terms that are the same as or correspond to the above embodiments will not be elaborated here again.

As shown in FIG. 2, the method of this embodiment may comprise:

S210. Acquire a sample initial image to be extracted and a sample initial edge mask image corresponding to the sample initial image to be extracted.

S220. Scale the sample initial image to be extracted to obtain a sample initial image to be extracted with a first size.

The scaling may be either zooming in or zooming out. Exemplarily, it may be a scale function. The first size may be a size of the sample initial image to be extracted that has been scaled.

The sample initial image to be extracted is scaled in length and/or width according to a preset ratio, such that the sample initial image to be extracted with the first size may be obtained. The preset ratio may be any preset ratio, which may comprise a preset length ratio and a preset width ratio. The preset length ratio may be a ratio of a length in the first size to a length of the sample initial image to be extracted, and the preset width ratio may be a ratio of a width in the first size to a width of the sample initial image to be extracted. The preset length ratio and the preset width ratio may be the same or different. For example, a value of the preset ratio may be 0.5, 0.7, 1.2, 1.5, and the like.

Based on the technical solutions of the embodiments of the present disclosure, the length and width of the sample initial image to be extracted may be scaled separately. For example, the length and width of the sample initial image to be extracted may be scaled separately according to a preset size transformation range.

The preset size transformation range may be a range to which the preset ratio for scaling the sample initial image to be extracted belongs. The advantage of setting the preset size transformation range is to avoid image quality loss caused by an excessive size change.

The length and width of the sample initial image to be extracted may be scaled according to any value within the preset size transformation range. For example, if the preset size transformation range is [0.5, 2], the preset length ratio may be any value within [0.5, 2],and the preset width ratio may be any value within the range of [0.5, 2].

The length and width of the sample initial image to be extracted may be scaled using the same ratio or different ratios.

S230. Interpolate the sample initial image to be extracted with the first size according to a nearest neighbor interpolatio n approach to obtain a sample target image to be extracted with a target size.

The nearest neighbor interpolation approach may be an approach for assigning a grayscale value of a pixel nearest to an original pixel point in a transformed image. The target size may be a preset desired image size, such as 512×512.

The sample initial image to be extracted with the first size is interpolated using the nearest neighbor interpolation approach, such that the size of the sample initial image to be extracted with the first size is adjusted from the first size to the target size, and thus the sample target image to be extracted with the target size is obtained.

Based on the technical solutions of the embodiments of the present disclosure, the sample initial image to be extracted with the first size may be cropped first, such that the length-to-width ratio of the cropped sample initial image to be extracted conforms to a preset length-to-width ratio. For example, interpolating the sample initial image to be extracted with the first size according to the nearest neighbor interpolation approach may comprise:

Cropping the sample initial image to be extracted with the first size according to the preset length-to-width ratio, and interpolating the cropped sample initial image to be extracted according to the nearest neighbor interpolation approach.

The preset length-to-width ratio may be a preset ratio of a length to width of an image, such as 1:1, 4:3, 16:9, and the like.

The sample initial image to be extracted with the first size may be cropped according to the preset length-to-width ratio to obtain at least one cropped sample initial image to be extracted. Then, the at least one cropped sample initial image to be extracted is interpolated using the nearest neighbor interpolation approach.

The sample initial image to be extracted with the first size may be cropped randomly according to the preset length-to-width ratio, such that a plurality of different images may be obtained, and each image may be considered as a cropped sample initial image to be extracted.

Based on the technical solutions of the embodiments of the present disclosure, the sample initial image to be extracted may be preprocessed, so as to improve the image quality of the sample initial image to be extracted. For example, the method further comprises, prior to scaling the sample initial image to be extracted: sharpening the sample initial image to be extracted.

S240. Perform image enhancement processing on the sample initial edge mask image to obtain a sample target edge mask image with the target size.

S250. Train an initial deep learning model according to the sample target image to be extracted and the sample target edge mask image corresponding to the sample initial image to be extracted to obtain a target edge extraction model.

According to the technical solutions of the embodiments of the present disclosure, the sample initial image to be extracted and the sample initial edge mask image corresponding to the sample initial image to be extracted are acquired; the sample initial image to be extracted is scaled to obtain the sample initial image to be extracted with the first size; and the sample initial image to be extracted with the first size is interpolated using the nearest neighbor interpolation approach to obtain the sample target image to be extracted with the target size. As such, the sample initial image to be extracted is expanded, and the size of the sample initial image to be extracted is adjusted. The image enhancement processing is performed on the sample initial edge mask image to obtain the sample target edge mask image with the target size; the initial deep learning model is trained according to the sample target image to be extracted and the sample target edge mask image corresponding to the sample target image to be extracted to obtain the target edge extraction model. This solves the problem of a poor model training effect caused by a small number of sample initial images to be extracted, and achieves the effect of improving the model training quality by performing the sample expansion on the sample target image to be extracted.

### Embodiment III

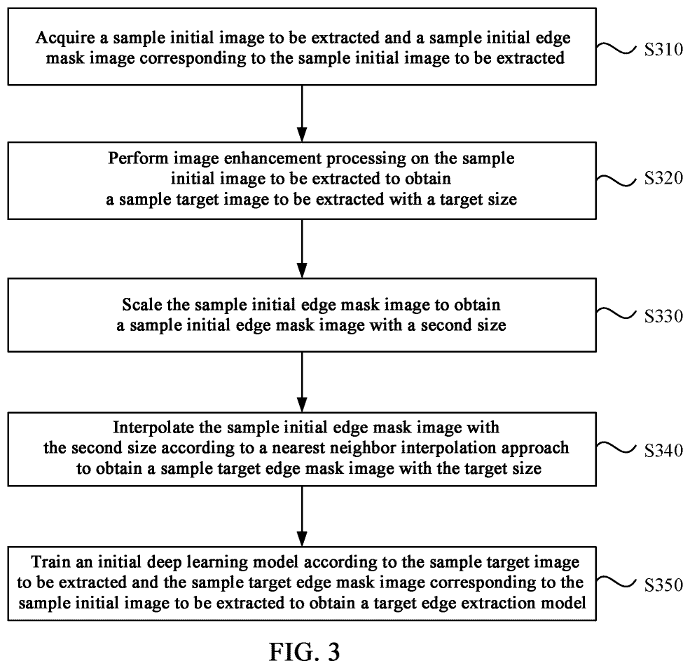

FIG. 3 is a flowchart of a training method of a target edge extraction model according to Embodiment III of the present disclosure. This embodiment is explained based on any technical solution of the embodiments of the present disclosure, and the method for performing image enhancement processing on a sample initial image to be extracted may refer to the technical solution of this embodiment. The explanations of terms that are the same as or correspond to the above embodiments will not be elaborated here again.

As shown in FIG. 3, the method of this embodiment may comprise:

S310. Acquire a sample initial image to be extracted and a sample initial edge mask image corresponding to the sample initial image to be extracted.

S320. Perform image enhancement processing on the sample initial image to be extracted to obtain a sample target image to be extracted with a target size.

S330. Scale the sample initial edge mask image to obtain a sample initial edge mask image with a second size.

The second size may be a size of the sample initial edge mask image that has been scaled.

The sample initial edge mask image is scaled in length and/or width according to a preset ratio, such that the sample initial edge mask image with the second size may be obtained. The preset ratio may be any preset ratio, which may comprise a preset length ratio and a preset width ratio. The preset length ratio may be a ratio of a length in the second size to a length of the sample initial edge mask image, and the preset width ratio may be a ratio of a width in the second size to a width of the sample initial edge mask image. The preset length ratio and the preset width ratio may be the same or different. For example, a value of the preset ratio may be 0.5, 0.7, 1.2, 1.5, and the like.

Based on the technical solutions of the embodiments of the present disclosure, the length and width of the sample initial edge mask image may be scaled separately. For example, the length and width of the sample initial edge mask image may be scaled separately according to a preset size transformation range.

The preset size transformation range may be a range to which the preset ratio for scaling the sample initial edge mask image belongs. The advantage of setting the preset size transformation range is to avoid image quality loss caused by an excessive size change.

The length and width of the sample initial edge mask image may be scaled according to any value within the preset size transformation range. For example, if the preset size transformation range is [0.5, 2], the preset length ratio may be any value within [0.5, 2], and the preset width ratio may be any value within the range of [0.5, 2].

S340. Interpolate the sample initial edge mask image with the second size according to a nearest neighbor interpolation approach to obtain a sample target edge mask image with the target size.

The sample initial edge mask image with the second size is interpolated using the nearest neighbor interpolation approach, such that the size of the sample initial edge mask image with the second size is adjusted from the second size to the target size, and thus the sample initial edge mask image with the target size is obtained.

Based on the technical solutions of the embodiments of the present disclosure, the sample initial edge mask image with the second size may be cropped first, such that the length-to-width ratio of the cropped sample initial edge mask image conforms to a preset length-to-width ratio. For example, interpolating the sample initial edge mask image with the second size according to the nearest neighbor interpolation approach may comprise:

Cropping the sample initial edge mask image with the second size according to the preset length-to-width ratio, and interpolating the cropped sample initial edge mask image according to the nearest neighbor interpolation approach.

The preset length-to-width ratio may be a preset ratio of a length to width of an image, such as 1:1, 4:3, and 16:9.

The sample initial edge mask image with the second size may be cropped according to the preset length-to-width ratio to obtain at least one cropped sample initial edge mask image. Then, the at least one cropped sample initial edge mask image is interpolated using the nearest neighbor interpolation approach.

The sample initial edge mask image with the second size may be cropped randomly according to the preset length-to-width ratio, such that a plurality of different images may be obtained, and each image may be considered as a cropped sample initial edge mask image.

Based on the technical solutions of the embodiments of the present disclosure, due to the scaling and nearest neighbor interpolation performed on the sample initial edge mask image, there will be a certain loss for the edge pixel points. Therefore, an operation of the dilation following the thinning may be performed to reduce the image loss. For example, the method further comprises, prior to scaling the sample initial edge mask image: dilating the sample initial edge mask image; and the method further comprises, after the sample initial edge mask image with the second size is interpolated according to the nearest neighbor interpolation approach and prior to obtaining the sample target edge mask image with the target size: thinning the sample initial edge mask image.

The dilation processing may be an approach for adding pixel values at an edge of an image to dilate the overall pixel values and achieve the image dilation. The dilation processing may be such as the cv2.dilate function in OpenCV. The thinning processing may be an approach for reducing an edge of an image to achieve the image thinning effect. The thinning processing may be such as the cv2. thinning function in OpenCV.

Dilating the sample initial edge mask image prior to scaling the sample initial edge mask image can achieve the dilation of the edge pixel points in the sample initial edge mask image. For example, 1 pixel may be dilated to 3 pixels. Moreover, since the dilation is performed first, after the scaling and the nearest neighbor interpolation are performed, the thinning processing is performed on the processed sample initial edge mask image, so as to thin the edge pixel points. For example, 3 pixels may be thinned to 1 pixel. Then, the thinned sample initial edge mask image is determined as the sample target edge mask image with the target size.

S350. Train an initial deep learning model according to the sample target image to be extracted and the sample target edge mask image corresponding to the sample initial image to be extracted to obtain a target edge extraction model.

According to the technical solutions of the embodiments of the present disclosure, the sample initial image to be extracted and the sample initial edge mask image corresponding to the sample initial image to be extracted are acquired; the image enhancement processing is performed on the sample initial image to be extracted to obtain the sample target image to be extracted with the target size; the sample initial edge mask image is scaled to obtain the sample initial edge mask image with the second size; and the sample initial edge mask image with the second size is interpolated according to the nearest neighbor interpolation approach to obtain the sample target edge mask image with the target size. As such, the edge information of the sample target edge mask image is enhanced and thus the edge effect is more obvious and accurate. The initial deep learning model is trained according to the sample target image to be extracted and the sample target edge mask image corresponding to the sample target image to be extracted to obtain the target edge extraction model. This solves the problem of the poor model training effect caused by insufficient edge information of the sample initial edge mask image, and achieves the effect of improving the model training quality by enhancing the edge information of the sample initial edge mask image.

### Embodiment IV

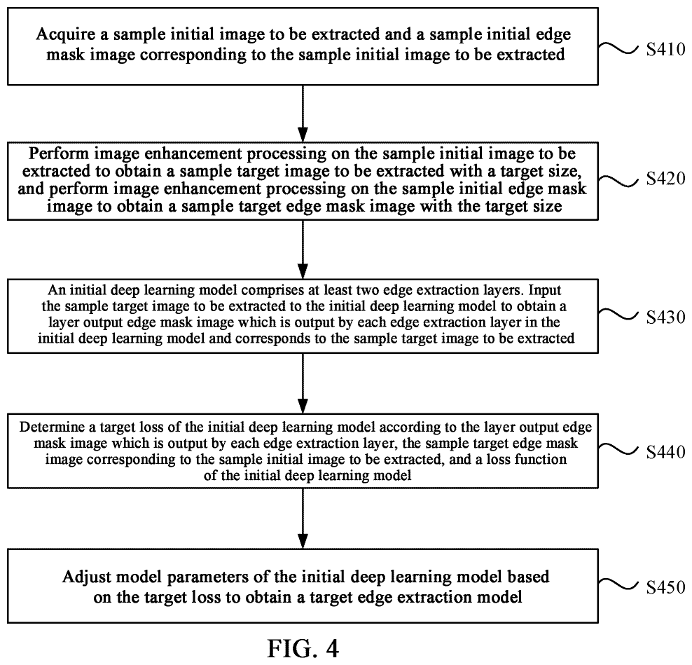

FIG. 4 is a flowchart of a training method of a target edge extraction model according to Embodiment IV of the present disclosure. This embodiment is explained based on any technical solution of the embodiments of the present disclosure, and the method for training the initial deep learning model to obtain the target edge extraction model may refer to the technical solution of this embodiment. The explanations of terms that are the same as or correspond to the above embodiments will not be elaborated here again.

As shown in FIG. 4, the method of this embodiment may comprise:

S410. Acquire a sample initial image to be extracted and a sample initial edge mask image corresponding to the sample initial image to be extracted.

S420. Perform image enhancement processing on the sample initial image to be extracted to obtain a sample target image to be extracted with a target size, and perform image enhancement processing on the sample initial edge mask image to obtain a sample target edge mask image with the target size.

S430. An initial deep learning model comprises at least two edge extraction layers. Input the sample target image to be extracted to the initial deep learning model to obtain a layer output edge mask image which is output by each edge extraction layer in the initial deep learning model and corresponds to the sample target image to be extracted.

The edge extraction layer may be a network layer in the initial deep learning model. The layer output edge mask image may be an edge mask image corresponding to an output result of the edge extraction layer.

The sample target image to be extracted is input to the initial deep learning model, and processed via each edge extraction layer in the initial deep learning model in sequence, such that the output result of each edge extraction layer may be obtained. For each edge extraction layer, the output result of the edge extraction layer may be converted to a value within the range of 0 to 1 through activation and binarization processing. Then the value is processed to be converted to 0 or 1 and the processing result is determined as the layer output edge mask image corresponding to the sample target image to be extracted.

Based on the technical solutions of the embodiments of the present disclosure, the edge extraction layer comprises a convolution module and an upsampling module. Obtaining the layer output edge mask image which is output by each edge extraction layer in the initial deep learning model and corresponds to the sample target image to be extracted may comprise:

For each edge extraction layer in the initial deep learning model, convolving a layer input image of the edge extraction layer using the convolution module of the edge extraction layer, and upsampling the convolved layer input image using the upsampling module to obtain the layer output edge mask image corresponding to the sample target image to be extracted.

The upsampling module further comprises an activation function and binarization processing. The image that has been upsampled by each edge extraction layer is processed via the activation function (such as the Sigmoid function), such that the value of each pixel point in the upsampled image may be converted to be between 0 and 1, which is denoted as a probability image. The probability image is often an image that represents whether each pixel point in the sample target image to be extracted is an edge pixel point. Since it is needed to obtain the layer output edge mask image corresponding to the sample target image to be extracted, that is, obtaining an image with a pixel probability value represented by 0 or 1, the probability image may be converted to a layer output edge mask image through binarization processing. For example, the value of each pixel point in the probability image may be converted to 0 or 1.

The layer output edge mask image and the sample target edge mask image have the same sizes. The convolution module is configured for convolution. The upsampling module is configured for upsampling, and may be further configured for activation and binarization processing. The layer input image may be an image input to the edge extraction layer. Exemplarily, if a current edge extraction layer is the first edge extraction layer in the initial deep learning model, the layer input image of the current edge extraction layer is the sample target image to be extracted. If a current edge extraction layer is the second edge extraction layer in the initial deep learning model or an edge extraction layer behind the second edge extraction layer, the layer input image of the current edge extraction layer is the layer output edge mask image of the previous edge extraction layer of the current edge extraction layer.

For each edge extraction layer in the initial deep learning model, the convolution module of the edge extraction layer is used to convolve the layer input image of the edge extraction layer. A size of the convolved layer input image is different from that of the original layer input image, and thus the upsampling module is used to upsample the convolved layer input image, so as to restore the size of the convolved layer input image to the size of the sample target edge mask image. Then, the upsampled layer input image is processed through the activation function and the binarization processing to obtain the layer output edge mask image corresponding to the sample target image to be extracted.

S440. Determine a target loss of the initial deep learning model according to the layer output edge mask image which is output by each edge extraction layer, the sample target edge mask image corresponding to the sample initial image to be extracted, and a loss function of the initial deep learning model.

The loss function of the initial deep learning model may be a preset function used for determining a loss. The loss function may be Mean Square Error Loss (MSE Loss), Mean Absolute Error Loss (MAE Loss), and the like. The target loss of the initial deep learning model may be a value obtained by comprehensively measuring differences between the plurality of layer output edge mask images and the sample target image to be extracted.

For the layer output edge mask image which is output by each edge extraction layer, the loss corresponding to the edge extraction layer may be determined by calculating the loss function of the initial deep learning model according to the layer output edge mask image and the sample target edge mask image corresponding to the sample target image to be extracted. Then, the target loss of the whole initial deep learning model may be obtained according to the determined losses.

Based on the technical solutions of the embodiments of the present disclosure, the target loss function of the initial deep learning model may be determined according to the following steps:

Step I. Calculate, for the layer output edge mask image which is output by each edge extraction layer and according to the loss function of the initial deep learning model, a layer output loss between the layer output edge mask image and the sample target edge mask image corresponding to the sample target image to be extracted.

The layer output loss may be the difference information between the layer output edge mask image and the sample target edge mask image corresponding to the sample target image to be extracted.

For the layer output edge mask image which is output by each edge extraction layer, calculation is performed on the layer output edge mask image and the sample target edge mask image corresponding to the sample target image to be extracted using the loss function of the initial deep learning model, such that the layer output loss corresponding to the edge extraction layer is obtained.

Step II. Determine an initial loss of the initial deep learning model according to the layer output losses corresponding to the plurality of edge extraction layers, and determine the target loss according to the initial loss.

The initial loss may be a loss determined comprehensively according to the plurality of layer output losses.

After the layer output losses corresponding to the plurality of edge extraction layers are obtained, the initial loss of the initial deep learning model may be determined by integrating and analyzing the plurality of layer output losses. Then, the initial loss may be determined as the target loss. The initial loss may also be scaled and/or processed by adding other items, and the processed initial loss may be used as the target loss.

Based on the technical solutions of the embodiments of the present disclosure, the target loss may be determined based on the initial loss through the following steps:

Step I. Determine the edge pixel points in the sample target edge mask image as positive sample pixel points, and determine pixel points in the sample target edge mask image other than the edge pixel points as negative sample pixel points.

The edge pixel points may be pixel points for describing an image edge. The positive sample pixel points are the edge pixel points in the sample target edge mask image. The negative sample pixel points are a number of pixel points in the sample target edge mask image other than the edge pixel points, namely, non-edge pixel points in the sample target edge mask image. Alternatively, the negative sample pixel points may be considered to be other pixel points in the sample target edge mask image other than the positive sample pixel points.

Step II. Determine a number of the positive sample pixel points in the sample target edge mask image, a number of the negative sample pixel points in the sample target edge mask image, and a total number of pixel points in the sample target edge mask image.

The number of the positive sample pixel points may be a total number of the positive sample pixel points in the sample target edge mask image. The number of the negative sample pixel points may be a total number of the negative sample pixel points in the sample target edge mask image. The total number of the pixel points is a total number of the pixel points in the sample target edge mask image, namely, a sum of the number of the positive sample pixel points and the number of the negative sample pixel points.

The number of the positive sample pixel points may be obtained by counting the positive sample pixel points in the sample target edge mask image. The number of the negative sample pixel points may also be obtained by counting the negative sample pixel points in the sample target edge mask image. It is also possible to obtain the total number of the pixel points by counting all the pixel points in the sample target edge mask image. Since the sum of the number of the positive sample pixel points and the number of the negative sample pixel points is the total number of the pixel points, after any two of these values are determined, the other value may be determined by calculation.

Step III. Calculate a pixel point loss weight corresponding to each pixel point in the sample target image to be extracted according to the number of the positive sample pixel points, the number of the negative sample pixel points, and the total number of the pixel points.

The pixel point loss weight may be a weight used for calculating a loss value of a pixel point, and it depends on whether the pixel point is a positive sample pixel point or a negative sample pixel point.

A ratio of the number of the positive sample pixel points to the total number of the pixel points may be used as the pixel point loss weight corresponding to each positive sample pixel point in the sample target image to be extracted, and a ratio of the number of the negative sample pixel points to the total number of the pixel points may be used as the pixel point loss weight corresponding to each negative sample pixel point in the sample target image to be extracted.

Other mathematical calculations may also be performed according to the number of the positive sample pixel points, the number of the negative sample pixel points, and the total number of the pixel points, so as to obtain the pixel point loss weight corresponding to each pixel. This is not limited in this embodiment.

Step IV. Obtain the target loss corresponding to each pixel point by weighting the initial loss according to the pixel point loss weight corresponding to each pixel point.

After the pixel loss weight of each pixel point is determined, the loss weight of each pixel point is multiplied by the initial loss to obtain the target loss corresponding to each pixel point.

To obtain the target loss of the initial deep learning model according to the target losses corresponding to the plurality of pixel points, mathematical calculations may be performed on the target losses corresponding to the plurality of pixel points, such as summing or averaging. This is not limited in this embodiment.

The reason for weighting the initial loss according to the pixel point loss weight corresponding to each pixel point in the above method is that: in the sample target edge mask image, the number of the positive sample pixel points is much smaller than the number of the negative sample pixel points, which may lead to the problem of unequal numbers of samples and inaccurate loss calculation, and this may affect the subsequent training of the initial deep learning model. With the pixel point loss weights being set, the impact caused by the unequal numbers of samples can be adjusted effectively.

S450. Obtain a target edge extraction model by adjusting model parameters of the initial deep learning model based on the target loss.

If the target loss does not meet a preset requirement, the model parameters of the initial deep learning model are adjusted to improve the model performance. If the target loss meets the preset requirement, the current initial deep learning model may be used as the target edge extraction model. The current initial deep learning model is a network model corresponding to the target loss, which may be a model with the adjusted model parameters.

According to the technical solutions of the embodiments of the present disclosure, the sample initial image to be extracted and the sample initial edge mask image corresponding to the sample initial image to be extracted are acquired. The image enhancement processing is performed on the sample initial image to be extracted to obtain the sample target image to be extracted with the target size, and the image enhancement processing is performed on the sample initial edge mask image to obtain the sample target edge mask image with the target size. As such, the sample expansion can be achieved and the image quality can be improved. The initial deep learning model comprises at least two edge extraction layers. The sample target image to be extracted is input to the initial deep learning model to obtain the layer output edge mask image which is output by each edge extraction layer in the initial deep learning model and corresponds to the sample target image to be extracted. Then, the target loss of the initial deep learning model is determined according to the layer output edge mask image which is output by each edge extraction layer, the sample target edge mask image corresponding to the sample target image to be extracted, and the loss function of the initial deep learning model. As such, the target loss covers a plurality of edge extraction layers and the reliability of calculation of the target loss is improved. This solves the problem of the inaccurate determination of the target loss during the determination of the target loss based on an overall model output result, and solves the problem of the inaccurate model parameter adjustment caused by the inaccurate target loss. It is achieved to determine the target loss more accurately and train the target edge extraction model in a better way, such that the edge information in the image can be extracted more accurately.

### Embodiment V

Embodiment V of the present disclosure provides a method of edge extraction and model training, comprising:

1. Acquiring, from a network database, a sample initial image to be extracted set A [A1, A2, . . . , An] and a sample initial edge mask image set B [B1, B2, . . . , Bn] corresponding to sample initial images to be extracted.

Exemplarily, PASCAL and labeled data are acquired from a Berkeley Segmentation Dataset and Benchmark (BSDS) database.

2. Performing, for each sample initial image to be extracted in the sample initial image to be extracted set A, the sharpening processing and the following scaling processing, to obtain a sample initial image to be extracted set A′[A′1, A′2, . . . , A′n] with a first size; and performing, for each sample initial image to be extracted in the sample initial image to be extracted set A′, the cropping processing and the nearest neighbor interpolation processing, to obtain a sample target image to be extracted set A″[A″1, A″2, . . . , A″n] with a target size.

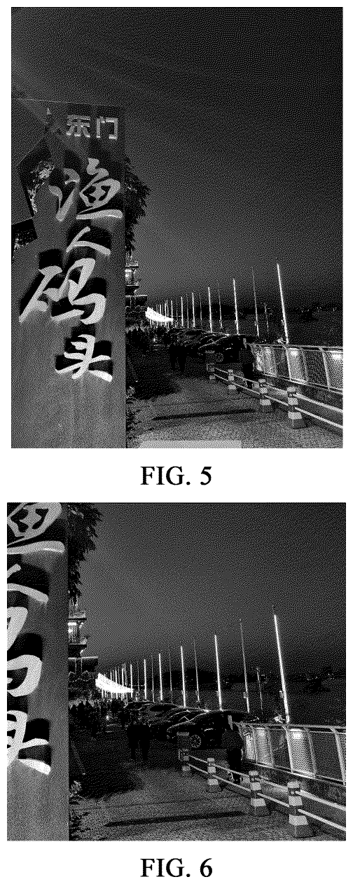

Exemplarily, image (sample initial image to be extracted)->sharp->scale (0.5, 2.0) (random scaling of a length and a width in the range of 0.5 to 2)->nearest resize (nearest neighbor interpolation). FIG. 5 shows a schematic diagram of a sample initial image to be extracted. FIG. 6 shows a schematic diagram of a sample target image to be extracted.

3. Performing, for each sample initial edge mask image in the sample initial edge mask image set B, the dilation processing and the following scaling processing, to obtain a sample initial edge mask image set B′ [B′1, B′2, . . . , B′n] with a second size; and performing, for each sample initial edge mask image set in the sample initial edge mask image set B′, the cropping processing, the nearest neighbor interpolation processing and the thinning processing, to obtain a sample target edge mask image set B″[B″1, B″2, . . . , B″n] with the target size.

Exemplarily, mask (sample initial edge mask image)->cv2.dilate (dilation processing)->scale (0.5,2.0) (random scaling of a length and a width in the range of 0.5 to 2)->nearest resize (nearest neighbor interpolation)->cv2.thinning (thinning processing). For example, the size of the sample initial edge mask image is 1024×768; the second size is 512×1536; and the target size is 512×512.

4. Inputting a plurality of sample target images to be extracted in the sample target image to be extracted set A″ to an initial deep learning model to obtain, for each sample target image to be extracted, layer output edge mask images output by a plurality of edge extraction layers; and performing the loss calculation respectively for the plurality of layer output edge mask images and a target edge mask image corresponding to the sample target image to be extracted to obtain an initial loss.

Exemplarily, the initial deep learning model comprises five edge extraction layers. The sample target image to be extracted A″m is processed by the initial deep learning model. A layer output loss Loss1 may be determined according to the layer output edge mask image Am1 of the first edge extraction layer and the sample target edge mask image B″m. In this way, layer output losses Loss2, Loss3, Loss4, and Loss5 may be determined.

5. Calculating a pixel point loss weight corresponding to each pixel point in the sample target image to be extracted according to a number of positive sample pixel points, a number of negative sample pixel points, and a total number of pixel points in each sample target image to be extracted; and weighting the initial loss according to the pixel point loss weight corresponding to each pixel point to obtain a target loss corresponding to each pixel point.

6. Determining a target loss of each sample target image to be extracted according to the target loss corresponding to each pixel point, and then determining a target loss of the initial deep learning model, so as to adjust model parameters of the initial deep learning model to obtain a target edge extraction model.

7. Inputting a target image to be extracted C to the target edge extraction model to obtain a target edge mask image D.

If the target edge extraction model is trained with a low-resolution (for example, resolution 512×512) sample initial image to be extracted set and a sample initial edge mask image set, the target edge extraction model may also be used for the edge extraction of a higher-resolution (for example, resolution 1024×1024) target image to be extracted.

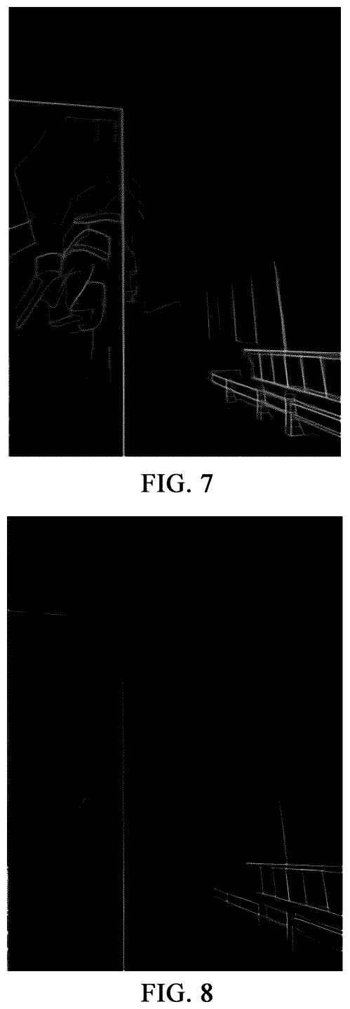

Exemplarily, FIG. 7 shows a schematic diagram of a target edge mask image output by a target edge extraction model.

8. Adjusting the image brightness of the target edge mask image D based on a preset color lookup table.

Exemplarily, FIG. 8 shows a schematic diagram of a target edge mask image after image brightness adjustment.

9. Recognizing edge pixel points in the target edge mask image based on a preset contour recognition algorithm, and storing the recognized edge pixel points in the form of point vectors.

Exemplarily, a fine contour is obtained through the find contour function (contour recognition algorithm) and cv2.thinning, and the form of point vector of each edge pixel point is obtained for the subsequent dynamic edge line processing.

According to the technical solutions of the embodiments of the present disclosure, the sample initial image to be extracted set and the sample initial edge mask image set corresponding to the sample initial images to be extracted are acquired; the image enhancement processing is performed on the plurality of sample initial images to be extracted to obtain the plurality of sample target images to be extracted with the target size, and the image enhancement processing is performed on the plurality of sample initial edge mask images to obtain the plurality of sample target edge mask images with the target size. As such, the sample expansion is achieved and the image quality is improved. The initial deep learning model is trained according to the plurality of sample target images to be extracted and the plurality of sample target edge mask images corresponding to the plurality of sample target images to be extracted to obtain the target edge extraction model. This solves the problem that the image edge extraction result is rough and imprecise, and thus achieves the effect of extracting edge information in the image more accurately.

### Embodiment VI

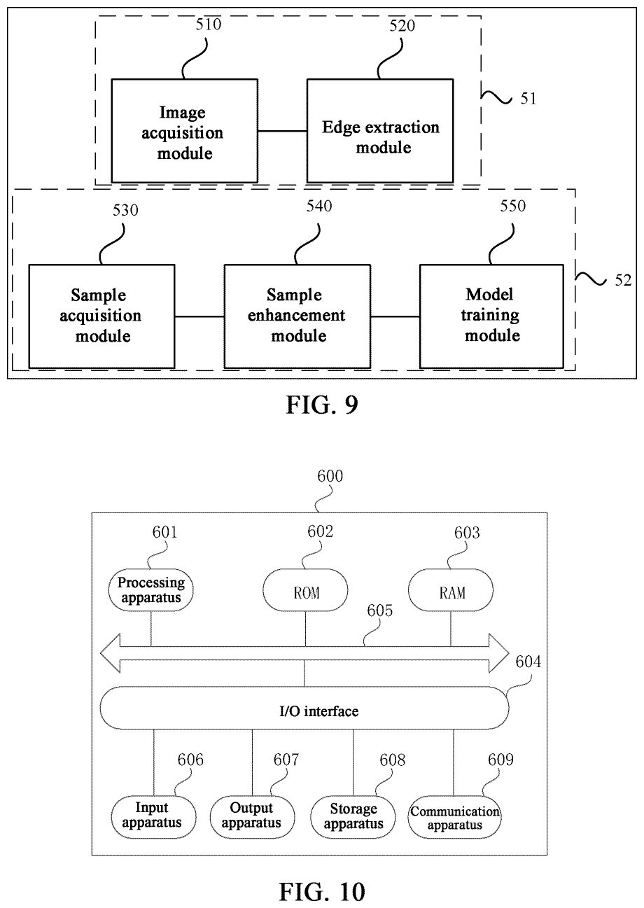

FIG. 9 is a schematic structural diagram of an edge extraction apparatus and a model training apparatus according to Embodiment VI of the present disclosure. The edge extraction apparatus 51 and the model training apparatus 52 provided in this embodiment may be implemented by software and/or hardware and may be configured in a terminal and/or a server to implement the edge extraction method in the embodiments of the present disclosure.

The edge extraction apparatus 51 may comprise: an image acquisition module 510 and an edge extraction module 520.

The image acquisition module 510 is configured for acquiring a target image to be extracted; and the edge extraction module 520 is configured for inputting the target image to be extracted to a target edge extraction model to obtain a target edge mask image corresponding to the target image to be extracted.

The model training apparatus 52 comprises: a sample acquisition module 530, a sample enhancement module 540, and a model training module 550.

The sample acquisition module 530 is configured for acquiring a sample initial image to be extracted and a sample initial edge mask image corresponding to the sample initial image to be extracted. The sample enhancement module 540 is configured for performing image enhancement processing on the sample initial image to be extracted to obtain a sample target image to be extracted with a target size, and configured for performing image enhancement processing on the sample initial edge mask image to obtain a sample target edge mask image with the target size. The model training module 550 is configured for training an initial deep learning model according to the sample target image to be extracted and the sample target edge mask image corresponding to the sample initial image to be extracted to obtain the target edge extraction model.

Based on any technical solution in the embodiments of the present disclosure, the sample enhancement module 540 is further configured for: scaling the sample initial image to be extracted to obtain a sample initial image to be extracted with a first size; and interpolating the sample initial image to be extracted with the first size according to a nearest neighbor interpolation approach to obtain the sample target image to be extracted with the target size.

Based on any technical solution in the embodiments of the present disclosure, the sample enhancement module 540 is further configured for scaling a length and a width of the sample initial image to be extracted separately according to a preset size transformation range.

Based on any technical solution in the embodiments of the present disclosure, the model training apparatus 52 further comprises: an image sharpening module, configured for sharpening the sample initial image to be extracted.

Based on any technical solution in the embodiments of the present disclosure, the sample enhancement module 540 is further configured for: scaling the sample initial edge mask image to obtain a sample initial edge mask image with a second size; and interpolating the sample initial edge mask image with the second size according to a nearest neighbor interpolation approach to obtain the sample target edge mask image with the target size.

Based on any technical solution in the embodiments of the present disclosure, the model training apparatus 52 further comprises: an image dilation module, configured for dilating the sample initial edge mask image. The model training apparatus 52 further comprises: an image thinning module, configured for thinning the sample initial edge mask image.

Based on any technical solution in the embodiments of the present disclosure, the initial deep learning model comprises at least two edge extraction layers. The model training module 550 is configured for: inputting the sample target image to be extracted to the initial deep learning model to obtain a layer output edge mask image which is output by each edge extraction layer in the initial deep learning model and corresponds to the sample target image to be extracted; determining a target loss of the initial deep learning model according to the layer output edge mask image which is output by each edge extraction layer, the sample target edge mask image corresponding to the sample initial image to be extracted, and a loss function of the initial deep learning model; and adjusting model parameters of the initial deep learning model based on the target loss to obtain the target edge extraction model.

Based on any technical solution in the embodiments of the present disclosure, the model training module 550 is further configured for: calculating, for the layer output edge mask image output by each edge extraction layer, a layer output loss between the layer output edge mask image and the sample target edge mask image corresponding to the sample target image to be extracted according to the loss function of the initial deep learning model; and determining an initial loss of the initial deep learning model according to the layer output losses corresponding to the plurality of edge extraction layers, and determining the target loss according to the initial loss.

Based on any technical solution in the embodiments of the present disclosure, the model training module 550 is further configured for: determining edge pixel points in the sample target edge mask image as positive sample pixel points, and determining pixel points in the sample target edge mask image other than the edge pixel points as negative sample pixel points; determining a number of the positive sample pixel points in the sample target edge mask image, determining a number of the negative sample pixel points in the sample target edge mask image, and determining a total number of pixel points in the sample target edge mask image; calculating a pixel point loss weight corresponding to each pixel point in the sample target image to be extracted according to the number of the positive sample pixel points, the number of the negative sample pixel points, and the total number of the pixel points; and weighting the initial loss according to the pixel point loss weight corresponding to each pixel point to obtain a target loss corresponding to each pixel point.

Based on any technical solution in the embodiments of the present disclosure, each edge extraction layer comprises a convolution module and an upsampling module. The model training module 550 is further configured for: for each edge extraction layer in the initial deep learning model, convolving, using the convolution module of the edge extraction layer, a layer input image of the edge extraction layer, and upsampling, using the upsampling module, the convolved layer input image to obtain the layer output edge mask image corresponding to the sample target image to be extracted, wherein the layer output edge mask image and the sample target edge mask image have the same sizes.

Based on any technical solution in the embodiments of the present disclosure, the edge extraction apparatus 51 further comprises: a brightness adjustment module, configured for adjusting image brightness of the target edge mask image based on a preset color lookup table.

Based on any technical solution in the embodiments of the present disclosure, the edge extraction apparatus 51 further comprises: a contour recognition module, configured for: recognizing edge pixel points in the target edge mask image based on a preset contour recognition algorithm, and storing the recognized edge pixel points in the form of point vectors.

Based on any technical solution in the embodiments of the present disclosure, the initial deep learning model comprises a convolutional neural network model; and the convolutional neural network model comprises at least one of a u2net model, a unet model, a deeplab model, a transformer model, and a pidinet model.

The above apparatus may implement the method provided in any embodiment of the present disclosure, and has corresponding functional modules for implementing the method and corresponding beneficial effects.

According to technical solutions of the embodiments of the present disclosure, the target image to be extracted is acquired, and the target image to be extracted is input to the target edge extraction model to obtain the target edge mask image corresponding to the target image to be extracted for the edge extraction of the image. Moreover, the sample initial image to be extracted and the sample initial edge mask image corresponding to the sample initial image to be extracted are acquired; the image enhancement processing is performed on the sample initial image to be extracted to obtain the sample target image to be extracted with the target size, and the image enhancement processing is performed on the sample initial edge mask image to obtain the sample target edge mask image with the target size for the sample expansion and image quality improvement. The initial deep learning model is trained according to the sample target image to be extracted and the sample target edge mask image corresponding to the sample target image to be extracted to obtain the target edge extraction model. This solves the problem that the image edge extraction result is rough and imprecise, and thus achieves the effect of extracting edge information in the image more accurately.

The multiple units and modules comprised in the above apparatus are only divided according to a functional logic, but are not limited to the above division, as long as the corresponding functions may be achieved. In addition, the names of the multiple functional units are only for the purpose of distinguishing and are not used to limit the protection scope of the embodiments of the present disclosure.

### Embodiment VII

FIG. 10 is a schematic structural diagram of an electronic device according to Embodiment VII of the present disclosure. Reference is now made to FIG. 10 below, which illustrates a schematic structural diagram of an electronic device (namely, a terminal device or a server in FIG. 10) 600 suitable for implementing the embodiments of the present disclosure. The terminal device in the embodiments of the present disclosure may comprise, but are not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device 600 shown in FIG. 10 is only an example and should not impose any limitations on the functionality and scope of use of the embodiments of the present disclosure.

As shown in FIG. 10, the electronic device 600 may comprise a processing apparatus (such as a central processing unit and graphics processor) 601 that may perform various appropriate actions and processing according to programs stored in a Read-Only Memory (ROM) 602 or loaded from a storage apparatus 608 to a Random Access Memory (RAM) 603. Various programs and data required for operations of the electronic device 600 may also be stored in the RAM 603. The processing apparatus 601, the ROM 602, and the RAM 603 are connected to each other through a bus 605. An Input/Output (I/O) interface 604 is also connected to the bus 605.

Usually, following apparatuses may be connected to the I/O interface 604: an input apparatus 606 comprising a touch screen, a touchpad, a keyboard, a mouse, a camera, a microphone, an accelerometer, a gyroscope, and the like; an output apparatus 607 comprising a Liquid Crystal Display (LCD), a speaker, a vibrator, and the like; a storage apparatus 608 comprising a magnetic tape, a hard disk drive, and the like; and a communication apparatus 609. The communication apparatus 609 may allow the electronic device 600 to wirelessly or wiredly communicate with other devices to exchange data. Although FIG. 10 shows the electronic device 600 with various apparatuses, the electronic device 600 is not required to implement or have all the apparatuses shown, and may alternatively implement or have more or fewer apparatuses.

According to the embodiments of the present disclosure, the process described in the reference flowchart above may be implemented as a computer software program. For example, the embodiments of the present disclosure comprise a computer program product, comprising a computer program carried on a non-transitory computer-readable medium, and the computer program comprises program codes used for performing the methods shown in the flowcharts. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the methods of the embodiments of the present disclosure are executed.

Messages or names of information exchanged between a plurality of apparatuses in the implementations of the present disclosure are only for illustrative purposes and are not intended to limit the messages or the scope of the information.

The electronic device provided according to the embodiments of the present disclosure and the edge extraction method provided in the above embodiments belong to the same concept. Technical details not fully described in this embodiment may be found in the above embodiments, and this embodiment has the same effects as the above embodiments.

### Embodiment VIII

The embodiments of the present disclosure provide a computer storage medium for storing a computer program. The program, when executed by a processor, implements the edge extraction method provided in the above embodiments.

The computer-readable medium mentioned in the present disclosure may be a computer-readable signal medium, a computer-readable storage medium, or any combination of the computer-readable signal medium and the computer-readable storage medium. The computer-readable storage medium may be, for example, but not limited to, electric, magnetic, optical, electromagnetic, infrared, or semiconductor systems, apparatuses, or devices, or any combination of the above. Examples of the computer-readable storage medium may comprise but are not limited to: an electrical connection with one or more wires, a portable computer disk, a hard disk drive, a Random Access Memory (RAM), a Read-Only Memory (ROM), an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal media may comprise data signals propagated in a baseband or as part of a carrier wave, which carries computer-readable program codes. The propagated data signals may be in various forms, comprising but not limited to: electromagnetic signals, optical signals, or any suitable combination of the above. The computer-readable signal medium may also be any computer-readable medium other than a computer-readable storage medium. The computer-readable signal medium may send, propagate, or transmit programs for use by or in combination with an instruction execution system, apparatus, or device. The program codes contained in the computer-readable medium may be transmitted using any suitable medium, comprising but not limited to: a wire, an optical cable, a Radio Frequency (RF), and the like, or any suitable combination of the above.

In some implementations, clients and servers may communicate using any currently known or future developed network protocol such as a HyperText Transfer Protocol (HTTP), and may intercommunicate and be interconnected with digital data in any form or medium (for example, a communication network). Examples of the communication network comprise a Local Area Network (LAN), a Wide Area Network (WAN), an internet (such as an Internet), a point-to-point network (such as an ad hoc point-to-point network, and any currently known or future developed network.

The computer-readable medium may be comprised in the electronic device or exist alone and is not assembled into the electronic device.

The above computer-readable medium carries one or more programs. When executed by the electronic device, the one or more programs cause the electronic device to:
acquire a target image to be extracted; and input the target image to be extracted to a target edge extraction model to obtain a target edge mask image corresponding to the target image to be extracted, wherein the target edge extraction model is trained by: acquiring a sample initial image to be extracted and a sample initial edge mask image corresponding to the sample initial image to be extracted; performing image enhancement processing on the sample initial image to be extracted to obtain a sample target image to be extracted with a target size, and performing image enhancement processing on the sample initial edge mask image to obtain a sample target edge mask image with the target size; and training an initial deep learning model according to the sample target image to be extracted and the sample target edge mask image corresponding to the sample initial image to be extracted to obtain the target edge extraction model.

Computer program codes for performing the operations of the present disclosure may be written in one or more programming languages or a combination thereof. The above programming languages comprise but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, comprising a LAN or a WAN, or may be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code comprises one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure may be implemented through software or hardware. The name of the unit does not constitute a limitation on the unit itself.

The functions described herein above may be performed, at least in part, by one or a plurality of hardware logic components. For example, without any limitation, demonstration types of hardware logic components that may be used comprise: a Field Programmable Gate Array (FPGA), an Application Specific Integrated Circuit (ASIC), an Application Specific Standard Part (ASSP), a System on Chip (SOC), a Complex Programmable Logic Device (CPLD), and the like.

In the context of the present disclosure, a machine-readable medium may be a tangible medium that may comprise or store a program for use by an instruction execution system, apparatus, or device or in connection with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the above content. Examples of the machine-readable storage medium may comprise an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the present disclosure, [symbol] Example I [symbol] provides an edge extraction method. The method comprises:
acquiring a target image to be extracted; and
inputting the target image to be extracted to a target edge extraction model to obtain a target edge mask image corresponding to the target image to be extracted,
wherein the target edge extraction model is trained by:
acquiring a sample initial image to be extracted and a sample initial edge mask image corresponding to the sample initial image to be extracted;
performing image enhancement processing on the sample initial image to be extracted to obtain a sample target image to be extracted with a target size, and performing image enhancement processing on the sample initial edge mask image to obtain a sample target edge mask image with the target size; and
training an initial deep learning model according to the sample target image to be extracted and the sample target edge mask image corresponding to the sample initial image to be extracted to obtain the target edge extraction model.

According to one or more embodiments of the present disclosure, [symbol] Example II [symbol] provides an edge extraction method. The method further comprises:
the performing image enhancement processing on the sample initial image to be extracted to obtain a sample target image to be extracted with a target size comprises: scaling the sample initial image to be extracted to obtain a sample initial image to be
extracted with a first size; and
interpolating the sample initial image to be extracted with the first size according to a nearest neighbor interpolation approach to obtain the sample target image to be extracted with the target size.

According to one or more embodiments of the present disclosure, [symbol] Example III [symbol] provides an edge extraction method. The method further comprises:
scaling the sample initial image to be extracted comprises:
scaling a length and a width of the sample initial image to be extracted separately according to a preset size transformation range.

According to one or more embodiments of the present disclosure, [symbol] Example IV [symbol] provides an edge extraction method. The method further comprises:
prior to scaling the sample initial image to be extracted, the method further comprises:
sharpening the sample initial image to be extracted.

According to one or more embodiments of the present disclosure, [symbol] Example V [symbol] provides an edge extraction method. The method further comprises:
performing the image enhancement processing on the sample initial edge mask image to obtain the sample target edge mask image with the target size comprises:
scaling the sample initial edge mask image to obtain a sample initial edge mask image with a second size; and
interpolating the sample initial edge mask image with the second size according to a nearest neighbor interpolation approach to obtain the sample target edge mask image with the target size.

According to one or more embodiments of the present disclosure, [symbol] Example VI [symbol] provides an edge extraction method. The method further comprises:
prior to the scaling the sample initial edge mask image, the method further comprises:
dilating the sample initial edge mask image; and
after interpolating the sample initial edge mask image with the second size according to the nearest neighbor interpolation approach, and prior to obtaining the sample target edge mask image with the target size, the method further comprises:
thinning the sample initial edge mask image.

According to one or more embodiments of the present disclosure, [symbol] Example VII [symbol] provides an edge extraction method. The method further comprises:
the initial deep learning model comprises at least two edge extraction layers; and
training the initial deep learning model according to the sample target image to be extracted and the sample target edge mask image corresponding to the sample initial image to be extracted to obtain the target edge extraction model comprises:
inputting the sample target image to be extracted to the initial deep learning model to obtain a layer output edge mask image which is output by each edge extraction layer in the initial deep learning model and corresponds to the sample target image to be extracted;
determining a target loss of the initial deep learning model according to the layer output edge mask image which is output by each edge extraction layer, the sample target edge mask image corresponding to the sample initial image to be extracted, and a loss function of the initial deep learning model; and
adjusting model parameters of the initial deep learning model based on the target loss to obtain the target edge extraction model.

According to one or more embodiments of the present disclosure, [symbol] Example VIII [symbol] provides an edge extraction method. The method further comprises:
determining the target loss of the initial deep learning model according to the layer output edge mask image which is output by each edge extraction layer, the sample target edge mask image corresponding to the sample initial image to be extracted, and the loss function of the initial deep learning model comprises:
calculating, for the layer output edge mask image output by each edge extraction layer, a layer output loss between the layer output edge mask image and the sample target edge mask image corresponding to the sample target image to be extracted according to the loss function of the initial deep learning model; and
determining an initial loss of the initial deep learning model according to the layer output losses corresponding to the plurality of edge extraction layers, and determining the target loss according to the initial loss.

According to one or more embodiments of the present disclosure, [symbol] Example IX [symbol] provides an edge extraction method. The method further comprises:
determining the target loss according to the initial loss comprises:
determining edge pixel points in the sample target edge mask image as positive sample pixel points, and determining pixel points in the sample target edge mask image other than the edge pixel points as negative sample pixel points;
determining a number of the positive sample pixel points in the sample target edge mask image, determining a number of the negative sample pixel points in the sample target edge mask image, and determining a total number of pixel points in the sample target edge mask image;
calculating a pixel point loss weight corresponding to each pixel point in the sample target image to be extracted according to the number of the positive sample pixel points, the number of the negative sample pixel points, and the total number of the pixel points; and
weighting the initial loss according to the pixel point loss weight corresponding to each pixel point to obtain the target loss corresponding to each pixel point.

According to one or more embodiments of the present disclosure, [symbol] Example X [symbol] provides an edge extraction method. The method further comprises:
each edge extraction layer comprises a convolution module and an upsampling module; and
obtaining the layer output edge mask image which is output by each edge extraction layer in the initial deep learning model and corresponds to the sample target image to be extracted comprises:
convolving, for each edge extraction layer in the initial deep learning model and using the convolution module of the edge extraction layer, a layer input image of the edge extraction layer, and upsampling, using the upsampling module, the convolved layer input image to obtain the layer output edge mask image corresponding to the sample target image to be extracted, wherein the layer output edge mask image and the sample target edge mask image have the same sizes.

According to one or more embodiments of the present disclosure, [symbol] Example XI [symbol] provides an edge extraction method. The method further comprises:
after obtaining the target edge mask image corresponding to the target image to be extracted, the method further comprises:
adjusting image brightness of the target edge mask image based on a preset color lookup table.

According to one or more embodiments of the present disclosure, [symbol] Example XII [symbol] provides an edge extraction method. The method further comprises:
after obtaining the target edge mask image corresponding to the target image to be extracted, the method further comprises:
recognizing edge pixel points in the target edge mask image based on a preset contour recognition algorithm, and storing the recognized edge pixel points in the form of point vectors.

According to one or more embodiments of the present disclosure, [symbol] Example XIII [symbol] provides an edge extraction method. The method further comprises:
the initial deep learning model comprises a convolutional neural network model; and the convolutional neural network model comprises at least one of a u2net model, a unet model, a deeplab model, a transformer model, and a pidinet model.

According to one or more embodiments of the present disclosure, [symbol] Example XIV [symbol] provides an edge extraction apparatus. The apparatus comprises:
an image acquisition module, configured for acquiring a target image to be extracted;
an edge extraction module, configured for inputting the target image to be extracted to a target edge extraction model to obtain a target edge mask image corresponding to the target image to be extracted,
wherein the target edge extraction model is obtained based on a model training apparatus, and the model training apparatus comprises:
a sample acquisition module, configured for acquiring a sample initial image to be extracted and a sample initial edge mask image corresponding to the sample initial image to be extracted;
a sample enhancement module, configured for performing image enhancement processing on the sample initial image to be extracted to obtain a sample target image to be extracted with a target size, and performing image enhancement processing on the sample initial edge mask image to obtain a sample target edge mask image with the target size; and
a model training module, configured for training an initial deep learning model according to the sample target image to be extracted and the sample target edge mask image corresponding to the sample initial image to be extracted to obtain the target edge extraction model.

In addition, although multiple operations are depicted in a specific order, this should not be understood as requiring these operations to be executed in the specific order shown or in a sequential order. In certain environments, multitasking and parallel processing may be advantageous. Similarly, although a plurality of implementation details are comprised in the above discussion, these should not be interpreted as limiting the scope of the present disclosure. Some features described in the context of individual embodiments may also be combined and implemented in a single embodiment. On the contrary, various features that are described in the context of the single embodiment may also be implemented in a plurality of embodiments separately or in any suitable sub-combinations.

1. An edge extraction method, comprising:
acquiring a target image to be extracted; and
inputting the target image to be extracted to a target edge extraction model to obtain a target edge mask image corresponding to the target image to be extracted,
wherein the target edge extraction model is trained by:
acquiring a sample initial image to be extracted and a sample initial edge mask image corresponding to the sample initial image to be extracted;
performing image enhancement processing on the sample initial image to be extracted to obtain a sample target image to be extracted with a target size, and performing image enhancement processing on the sample initial edge mask image to obtain a sample target edge mask image with the target size; and
training an initial deep learning model according to the sample target image to be extracted and the sample target edge mask image corresponding to the sample initial image to be extracted to obtain the target edge extraction model.

2. The method of claim 1, wherein performing the image enhancement processing on the sample initial image to be extracted to obtain the sample target image to be extracted with the target size comprises:
scaling the sample initial image to be extracted to obtain a sample initial image to be extracted with a first size; and
interpolating the sample initial image to be extracted with the first size according to a nearest neighbor interpolation approach to obtain the sample target image to be extracted with the target size.

3. The method of claim 2, wherein scaling the sample initial image to be extracted comprises:
scaling a length and a width of the sample initial image to be extracted separately according to a preset size transformation range.

4. The method of claim 2, wherein the method further comprises prior to scaling the sample initial image to be extracted:
sharpening the sample initial image to be extracted.

5. The method of claim 1, wherein performing the image enhancement processing on the sample initial edge mask image to obtain the sample target edge mask image with the target size comprises:
scaling the sample initial edge mask image to obtain a sample initial edge mask image with a second size; and
interpolating the sample initial edge mask image with the second size according to a nearest neighbor interpolation approach to obtain the sample target edge mask image with the target size.

6. The method of claim 5, wherein the method further comprises prior to scaling the sample initial edge mask image:
dilating the sample initial edge mask image; and
the method further comprises after interpolating the sample initial edge mask image with the second size according to the nearest neighbor interpolation approach, and prior to obtaining the sample target edge mask image with the target size:
thinning the sample initial edge mask image.

7. The method of claim 1, wherein the initial deep learning model comprises at least two edge extraction layers; and
training the initial deep learning model according to the sample target image to be extracted and the sample target edge mask image corresponding to the sample initial image to be extracted to obtain the target edge extraction model comprises:
inputting the sample target image to be extracted to the initial deep learning model to obtain a layer output edge mask image which is output by each edge extraction layer in the initial deep learning model and corresponds to the sample target image to be extracted;
determining a target loss of the initial deep learning model according to the layer output edge mask image which is output by each edge extraction layer, the sample target edge mask image corresponding to the sample initial image to be extracted, and a loss function of the initial deep learning model; and
adjusting model parameters of the initial deep learning model based on the target loss to obtain the target edge extraction model.

8. The method of claim 7, wherein determining the target loss of the initial deep learning model according to the layer output edge mask image which is output by each edge extraction layer, the sample target edge mask image corresponding to the sample initial image to be extracted, and the loss function of the initial deep learning model comprises:
calculating, for the layer output edge mask image which is output by each edge extraction layer, a layer output loss between the layer output edge mask image and the sample target edge mask image corresponding to the sample target image to be extracted according to the loss function of the initial deep learning model; and
determining an initial loss of the initial deep learning model according to the layer output losses corresponding to a plurality of edge extraction layers, and determining the target loss according to the initial loss.

9. The method of claim 8, wherein determining the target loss according to the initial loss comprises:
determining edge pixel points in the sample target edge mask image as positive sample pixel points, and determining pixel points in the sample target edge mask image other than the edge pixel points as negative sample pixel points;
determining a number of the positive sample pixel points in the sample target edge mask image, and determining a number of the negative sample pixel points in the sample target edge mask image, and determining a total number of pixel points in the sample target edge mask image;
calculating a pixel point loss weight corresponding to each pixel point in the sample target image to be extracted according to the number of the positive sample pixel points, the number of the negative sample pixel points, and the total number of the pixel points; and
weighting the initial loss according to the pixel point loss weight corresponding to each pixel point to obtain a target loss corresponding to each pixel point.

10. The method of claim 7, wherein an edge extraction layer comprises a convolution module and an upsampling module; and
wherein obtaining the layer output edge mask image which is output by each edge extraction layer in the initial deep learning model and corresponds to the sample target image to be extracted comprises:
convolving, for each edge extraction layer in the initial deep learning model, a layer input image of the edge extraction layer using the convolution module of the edge extraction layer, and upsampling, using the upsampling module of the edge extraction layer, the convolved layer input image to obtain the layer output edge mask image corresponding to the sample target image to be extracted, wherein the layer output edge mask image and the sample target edge mask image have the same sizes.

11. The method of claim 1, wherein the method further comprises after obtaining the target edge mask image corresponding to the target image to be extracted:
adjusting image brightness of the target edge mask image based on a preset color lookup table.

12. The method of claim 1, wherein the method further comprises after obtaining the target edge mask image corresponding to the target image to be extracted:
recognizing edge pixel points in the target edge mask image based on a preset contour recognition algorithm, and storing the recognized edge pixel points in the form of point vectors.

13. The method of claim 1, wherein the initial deep learning model comprises a convolutional neural network model, and the convolutional neural network model comprises at least one of a u2net model, a unet model, a deeplab model, a transformer model, and a pidinet model.

14. (canceled)

15. An electronic device, comprising:
at least one processor; and
a storage apparatus, configured for storing at least one program,
wherein the at least one program, when executed by the at least one processor, causes the at least one processor to;
acquire a target image to be extracted; and
input the target image to be extracted to a target edge extraction model to obtain a target edge mask image corresponding to the target image to be extracted.
wherein the target edge extraction model is trained by:
acquiring a sample initial image to be extracted and a sample initial edge mask image corresponding to the sample initial image to be extracted;
performing image enhancement processing on the sample initial image to be extracted to obtain a sample target image to be extracted with a target size, and performing image enhancement processing on the sample initial edge mask image to obtain a sample target edge mask image with the target size; and
training an initial deep learning model according to the sample target image to be extracted and the sample target edge mask image corresponding to the sample initial image to be extracted to obtain the target edge extraction model.

16. A computer-readable storage medium, which stores a computer program, wherein the computer program, when executed by a processor, causes the processor to:
acquire a target image to be extracted; and
input the target image to be extracted to a target edge extraction model to obtain a target edge mask image corresponding to the target image to be extracted,
wherein the target edge extraction model is trained by:
acquiring a sample initial image to be extracted and a sample initial edge mask image corresponding to the sample initial image to be extracted;
performing image enhancement processing on the sample initial image to be extracted to obtain a sample target image to be extracted with a target size, and performing image enhancement processing on the sample initial edge mask image to obtain a sample target edge mask image with the target size; and
training an initial deep learning model according to the sample target image to be extracted and the sample target edge mask image corresponding to the sample initial image to be extracted to obtain the target edge extraction model.

17. (canceled).

18. The electronic device according to claim 15, wherein the at least one processor being caused to perform the image enhancement processing on the sample initial image to be extracted to obtain the sample target image to be extracted with the target size comprises being caused to:
scale the sample initial image to be extracted to obtain a sample initial image to be extracted with a first size; and
interpolate the sample initial image to be extracted with the first size according to a nearest neighbor interpolation approach to obtain the sample target image to be extracted with the target size.

19. The electronic device according to claim 18, wherein the at least one processor being caused to scale the sample initial image to be extracted comprises being caused to:
scale a length and a width of the sample initial image to be extracted separately according to a preset size transformation range.

20. The electronic device according to claim 18, wherein the at least one processor is further caused to prior to scaling the sample initial image to be extracted:
sharpening the sample initial image to be extracted.

21. The electronic device according to claim 15, wherein the at least one processor being caused to perform the image enhancement processing on the sample initial edge mask image to obtain the sample target edge mask image with the target size comprises being caused to:
scale the sample initial edge mask image to obtain a sample initial edge mask image with a second size; and
interpolate the sample initial edge mask image with the second size according to a nearest neighbor interpolation approach to obtain the sample target edge mask image with the target size.

22. The electronic device according to claim 21, wherein the at least one processor is further caused to prior to scaling the sample initial edge mask image:
dilate the sample initial edge mask image; and
wherein the at least one processor is further caused to after interpolating the sample initial edge mask image with the second size according to the nearest neighbor interpolation approach, and prior to obtaining the sample target edge mask image with the target size:
thinning the sample initial edge mask image.
